(19) United States
(12) Patent Application Publication
(10) Pub. No.: US 2023/0013584 A1
(43) Pub. Date: Jan. 19, 2023

(54) MANAGING METHOD OF FRAGMENTARY DIGITAL CREATION AND COMPUTER READABLE STORAGE MEDIUM

(71) Applicant: Chun-Jung LIN, Kaohsiung City (TW)

(72) Inventor: Chun-Jung LIN, Kaohsiung City (TW)

(21) Appl. No.: 17/709,386

(22) Filed: Mar. 30, 2022

(30) Foreign Application Priority Data
Jul. 19, 2021 (TW) 110126431

(51) Int. Cl. G06Q 20/12; G06Q 30/02; G06V 30/414; G10L 15/26; H04L 9/00; H04L 9/32

(52) U.S. Cl. CPC G06Q 20/123; G06Q 30/0283; G06V 30/414; G10L 15/26; H04L 9/50; H04L 9/3247

(57) ABSTRACT

A managing method of a fragmentary digital creation incorporated with a creation managing platform is disclosed. The method includes: receiving an uploaded digital creation by the creation managing platform; receiving a setting command to set a charging approach, a price and a profit-sharing mode of the digital creation; generating a text record corresponding to content of the digital creation through an algorithm; analyzing the digital creation through an AI model to divide the digital creation into multiple fragmentary creations; labeling each fragmentary creation according to the text record; computing a weighting value for each fragmentary creation with respect to the entire digital creation; computing a fragmentary price for each fragmentary creation based on the price and each weighting value; and storing the charging approach, the profit-sharing mode, multiple labeled fragmentary creations, each weighting value, and each fragmentary price to generate an online-executable smart contract.

### BACKGROUND OF THE DISCLOSURE

### Technical Field

The disclosure relates to a managing method and a computer readable storage medium, particularly relates to a managing method of a digital creation and a computer readable storage medium recording a computer program for implementing the managing method.

### Description of Related Art

The traditional creative industry faces the impact of transformation after the computer and Internet are universalized, particularly for the creations such as picture, article, image, music, and program code, etc.

Traditionally, the value evaluation of the aforementioned traditional creations is mainly based on the ownership of the creation. However, all of the creations are uploaded to the Internet to be the digital creation nowadays, and face the problem of easily replicating and piracy of copyright.

Further, comparing to the traditional creation, the digital creation is easier to be obtained and edited, and thus the user often does not use that in a manner of one entire book, one entire album, one entire movie, one entire picture or one entire code, but use one paragraph from the book, one rhythm from the song, one clip from the movie, one object from the picture, etc., or re-create by using those elements. In other words, the digital world is focusing on the use right of the digital creation and is no longer focusing on the ownership of the creation.

Taking the book as an example, when the book is digitalized to be the digital book, content of the book is easily to be divided into many single pages, or even be disintegrated into many excerpts in each page. In the digital world, the disintegrated excerpts are easily to be re-edited and mixed into the other books. Moreover, many writers begin to write the book for reading in a fragmentary manner, or further create the collection of mixing different pages.

As described above, the digital book with the functions of copying single excerpt, page, or article for the user after being purchased and read is the main engine for promoting the development of the books such as reference book, recipe, and travel guidebook. When the excerpts, pages or articles from the book are spread everywhere and capable of being mixed and transmitted, the creator may become prestigious and wealthy through creating outstanding collection.

However, currently, there is still no appropriate managing platform to provide a justified channel for the user to legally obtain and selectively use excerpt of the digital creation, and provide small amount reward for the creator based on the used excerpt. In view of this, the inventors have devoted themselves to the aforementioned related art, researched intensively try to solve the aforementioned problems.

### SUMMARY OF THE DISCLOSURE

The main object of the disclosure is to provide a managing method of a fragmentary digital creation and a computer readable storage medium recording the computer program capable of implementing the managing method, which the user may selectively purchase and use partial paragraphs in the digital creation, and the creator may have long-term profit based on the user's purchase and using condition.

In order to achieve the object, the managing method of the disclosure includes following steps: receiving, by the creation managing platform, a digital creation being uploaded; receiving a setting command to set a charging approach, a price and a profit-sharing mode; processing the digital creation, by an algorithm, to generate a text record corresponding to content of the digital creation; analyzing the digital creation, by an artificial intelligence model, to divide the digital creation into multiple fragmentary creations; respectively labeling the fragmentary creations according to the text record; calculating a weighting value of each fragmentary creation relative to the digital creation as a whole; calculating a fragmentary price of each fragmentary creation according to the price and the weighting value; and storing the charging approach, the profit-sharing mode, multiple labeled fragmentary creations, each weighting value and each fragmentary price to generate a smart contract of being executed online.

The technical effects of the disclosure comparing to the related art is as follows. The creation managing platform may automatically analyze the digital creation to divide (or segment) the entire digital creation into multiple fragmentary creations, and label those respectively. Therefore, the user may selectively search, purchase, and use one or multiple fragmentary creations, and pay the fragmentary creation by micropayment without purchasing the entire digital creation just for a small portion. Further, the creator of the digital creation may continuously make a profit based on the purchased and used fragmentary creation.

### BRIEF DESCRIPTION OF THE DRAWINGS

FIG. 1 is a schematic diagram of the first embodiment of the creation managing platform in accordance with some embodiments.

FIG. 2 is a flowchart of the first embodiment of the managing method in accordance with some embodiments.

FIG. 3 is a flowchart of the second embodiment of the managing method in accordance with some embodiments.

FIG. 4 is a schematic diagram of the first embodiment of the fragmentary creation in accordance with some embodiments.

FIG. 5 is a schematic diagram of the second embodiment of the fragmentary creation in accordance with some embodiments.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

The disclosure provides a managing method of a fragmentary digital creation (hereafter as the managing method), which is used to divide (or segment) the digital creation created by the creator into multiple fragmentary creations, and instantiate the smart contract according to the fragmentary creations to respectively manage the fragmentary creations. When each fragmentary creation is purchased or/and used by the user, the managing method of the disclosure may be used to charge the user for the creator according to one or multiple fragmentary creations being purchased or used. The information, such as the original release time, release location, and creator, etc., of the purchased or/and used fragmentary creation is trackable through the instantiation of the smart contract, and the copyright may be authenticated through the encrypted signature.

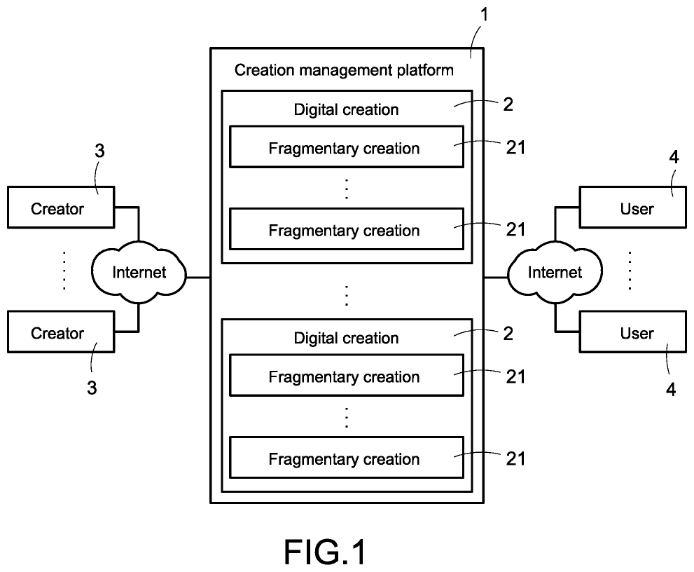

Please refer to FIG. 1, which is a schematic diagram of the first embodiment of the creation managing platform in accordance with some embodiments. The managing method of the disclosure is mainly applied to the online creation managing platform 1, for example, user generated-content (UGC) platform, here is not intended to be limiting.

Specifically, the creation managing platform 1 may be ran (or operated) on the computer or cloud server, and establish connection with the electronic devices (for example, the smart phone, tablet computer, personal computer, or server) of one or multiple creators 3 through the Internet to receive the digital creations 2 respectively uploaded by the creators 3. Further, the creation managing platform 1 may establish connection with the electronic devices (for example, the smart phone, tablet computer, personal computer, or server) of one or multiple users 4 through the Internet to accept the log-in from the user for performing the action, such as searching, purchasing, downloading, using, and re-creating, etc., to the required creation on the creation managing platform 1.

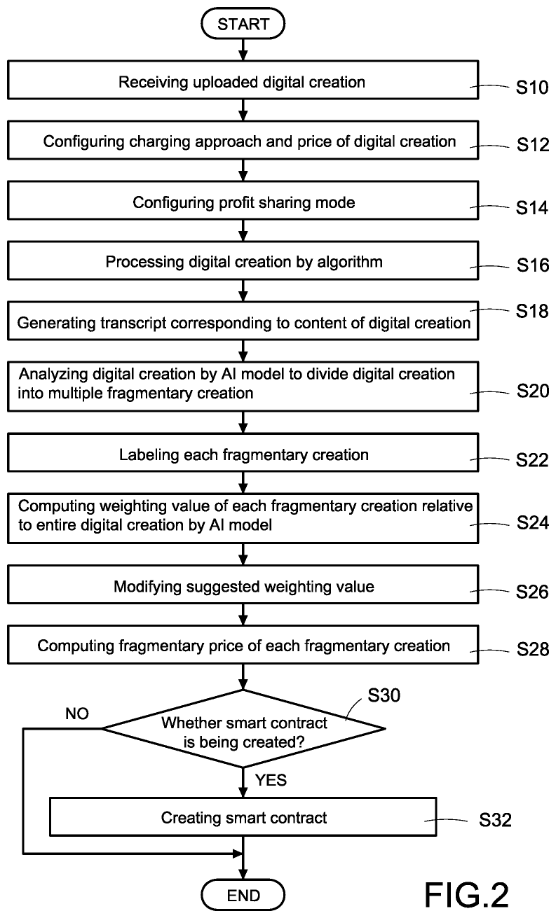

The managing method of the disclosure may be implemented by the computer program. Specifically, the execution steps (as shown in FIG. 2) in the managing method are respectively executed by the multiple lines of computer executable codes in the computer program product. In some embodiments, the computer program product includes the computer program as an application program interface (API) for the computer or server to connect and use. When the computer or server is configured to execute the computer program, the computer or server may complete the managing method of the disclosure based on the multiple lines of program codes.

As shown in FIG. 1, the creator 3 may connect the creation managing platform 1, which executes the managing method of the disclosure, through the Internet, and upload the digital creation 2 to the creation managing platform 1. In some embodiments, the digital creation may be, for example, an article creation, a picture creation, a video creation, a music creation, a program code creation, etc., here is not intended to be limiting.

In some embodiments, the creation managing platform 1 is instantiated on the blockchain. The creator 3 may upload the digital creation 2 to the creation managing platform 1 and instantiate the smart contract on the creation managing platform 1 to make the smart contract be executed on the blockchain. The creation managing platform 1 may add the encrypted signature of the creator 3 and the tracking code of the digital creation 2 into the smart contract by executing the smart contract on the blockchain. Therefore, after the digital creation 2 is released, the information, such as the source, release time, release manner, release location, etc., is trackable, and the copyright may be authenticated and encrypted to achieve the technical effect of traceability.

Specifically, the transaction conditions of the smart contract are confirmed by the contract subject (including the creation managing platform 1) and the contract terms of the smart contract are designated by the program code, and the smart contract is activated through the authentication (that is, the digital signature) from the privacy keys of all participants (including the creator 3) in the contract. The signed smart contract is written into the decentralized platform (that is, distributed between multiple nodes on the network) after being compiled, and is being executed when the preset contract condition is triggered.

The detail of the smart contract is omitted here for brevity.

One technical feature of the disclosure is that when the creator 3 uploads a digital creation 2 to the creation managing platform 1, the creation managing platform 1 may analyze the digital creation 2 through the managing method of the disclosure to segment the digital creation 2 into multiple fragmentary creations 21. In the disclosure, each fragmentary creation 21 is corresponding to different portions of the digital creation 2, and the fragmentary creations 21 may be set to have different weighting values, fragmentary prices, charging approaches, and using manners from one another.

For example, if the digital creation 2 is an article creation, each fragmentary creation 21 may be the chapters, pages, or paragraphs in the article creation. If the digital creation 2 is a picture creation, each fragmentary creation 21 may be the intact object elements (for example, the object elements, such as sun, sky, sea, beach, etc., included in the seashore photo) in the picture creation. If the digital creation 2 is a video creation, each fragmentary creation 21 may be different time periods (for example, every ten seconds as one fragmentary creation 21) or different scenes (for example, talking scene, driving scene, fighting scene, etc.) in the video creation. If the digital creation 2 is a music creation, each fragmentary creation 21 may be different time periods or different sections (for example, prelude, verse, chorus, interlude, epilogue, etc.) in the music creation. If the digital creation 2 is a program code creation, each fragmentary creation 21 may be different functional sections (for example, multiple sub-program for different functions) in the program code creation.

The aforementioned description is part of the embodiments of the disclosure, here is not intended to be limiting.

The users 4 may selectively search, purchase, and use specific one or multiple fragmentary creations 21 without purchasing the entire digital creation 2 based on their own purpose through the managing method of the disclosure. As a result, the users may avoid unnecessary payment and may be more willing to legally use the creation and pay the fee. Further, no matter how the digital creation 2 is purchased and used, the creator 3 may continuously make a profit.

Please refer to FIG. 2, which is a flowchart of the first embodiment of the managing method in accordance with some embodiments. FIG. 2 discloses the specific executing steps of the managing method of the disclosure. Each step may be completed by the computer program executed on the creation managing platform 1.

As shown in FIG. 2, first, the creation managing platform 1 is configured to accept the log-in from any creator 2, and receive one or multiple digital creations uploaded by the creator 3 (step S10). Next, the creation managing platform 1 is configured to receive the setting action executed by the creator 3 on the creation managing platform 1 to obtain the corresponding setting command. The creation managing platform 1 is configured to set the charging approach and price of the digital creation 2 (step S12) through the received setting command, and further set the profit-sharing mode (step S14), which the creator 3 desires, under the condition that the charging approach of the digital creation 2 is not free payment approach.

In some embodiments, the digital creation 2 may be, for example, an article creation, a picture creation, a video creation, a music creation, a program code creation, etc., here is not intended to be limiting.

In some embodiments, the charging approach may include a requiring payment approach, a free payment approach and a sponsorial payment approach, and may further include a charging standard of different using time (for example, using time point or using duration), a charging standard of different using locations (for example, local use or abroad use) and a charging standard of using manners (for example, single-use, multiple-uses, or re-creation), here is not intended to be limiting.

If the creator 3 set the charging approach of the digital creation 2 to be the requiring payment approach, the creation managing platform 1 is configured to allocate the creation charge to the creator 3, after the digital creation 2 is purchased or/and used, according to the profit-sharing mode set by the creator 3. If the creator 3 set the charging approach of the digital creation 2 to be the free payment approach or sponsorial payment approach, the creation managing platform 1 is configured to provide the corresponding award or reward to the creator 3, after the digital creation 2 is purchased or/and used, according to the customized mechanism (described as follows).

The profit-sharing mode indicates the charging manner which the creator 3 desires. In the first embodiment, the creator 3 may set to charge immediately after the creation is purchased or/and used. In the second embodiment, the creator 3 may set to charge periodically, for example, once per week, once per month, once per half year, etc. In the third embodiment, the creator 3 may set to charge when the fees are accumulated to predetermined amount. Here is not intended to be limiting.

It is worth mentioning that the creator 3 may set the heirship of the digital creation 2, or set to donate the creation charge. In some embodiments, when the creation managing platform 1 is configured to execute the smart contract, the creation managing platform 1 may automatically allocate the creation charge to the user 4 with heirship, or allocate the creation charge to the donated organization designated by the creator 3.

After the step S14, the creation managing platform 1 is configured to process the digital creation 2 uploaded by the creator 3 through specific algorithm (step S16) to generate the text record corresponding to content of the digital creation 2 (step S18). Further, the creation managing platform 1 is configured to analyze the digital creation 2 through the pre-trained artificial intelligence (not shown in figures) to divide the digital creation 2 into multiple fragmentary creations 21 (step S20).

In some embodiments, the manager of the creation managing platform 1 may train the artificial intelligence (AI) model through the combination of convolutional neural network (CNN) and deep learning. By the accumulation and training with big data, the AI model may analyze the input digital creation 2 to rapidly and effectively divide the digital creation 2 into multiple reasonable fragmentary creations 21 to meet the requirements.

Specifically, the step S16 is mainly used to analyze content of the digital creation 2 based on the execution of the algorithm, and transform the content into text which is capable of being searched, recognized, and used in deep learning. In the disclosure, the creation managing platform 1 is configured to use text as the basic unit (that is, bit) of deep learning.

In the first embodiment, the digital creation 2 is the article creation. The step S16 is used to execute an optical character recognition (OCR) algorithm to the article creation to generate the text record corresponding to content of the article creation in the step S18. In the second embodiment, the digital creation is the picture creation with voice, video creation or music creation. The step S16 is used to execute a speech to text algorithm to the picture creation with voice, video creation or music creation to generate the text record corresponding to content of the picture creation with voice, video creation or music creation in the step S18.

In the third embodiment, the digital creation 2 is the program code creation. The step S16 is used to obtain the definition and note created by the creator 3 with respect to multiple functional sections in the program code creation or analyze the functional sections in the program code creation to generate the text record corresponding to content of the program code creation in the step S18.

In the fourth embodiment, when the creator 3 uploads the digital creation 2, the creation managing platform 1 may be configured to receive one or multiple key words defined by the creator 3, and generate the text record of the digital creation 2 based on the key words.

The aforementioned description are the embodiments of the disclosure, here is not intended to be limiting.

In the disclosure, the creation managing platform 1 is configured to pre-train an AI model used to divide the digital creation 2 through deep learning. The AI model may analyze all kinds of digital creations 2 to divide the digital creation 2 into multiple fragmentary creations 21 based on the basic unit of each digital creation 2.

Specifically, the AI model is configured to define the basic fragmentary unit of all kinds of digital creations 2 through deep learning, and define the importance of all kinds of fragments relative to the entire digital creation 2. As a result, when the smart contract is instantiated, the creation managing platform 1 may be configured to segment all kinds of digital creations 2 through the trained model and calculate the weighting value of each fragmentary creation 21.

For example, if the digital creation 2 is article creation, the AI model may use single article paragraph as the basic unit in the step S20 to divide the entire article creation into multiple fragmentary creations 21. If the digital creation 2 is video creation or music creation, the AI model may use a fixed time period (for example, ten seconds, thirty seconds, one minute, etc.) as the basic unit in the step S20 to segment the entire video creation or music creation into multiple fragmentary creations 21. If the digital creation 2 is picture creation, the AI model may use the intact object element in the picture as the basic unit in the step S20 to divide the entire picture creation into multiple fragmentary creations 21. If the digital creation 2 is program code creation, the AI model may use each functional section of the program code as the basic unit in the step S20 to segment the entire program code creation into multiple fragmentary creations 21.

It is worth mentioning that if the digital creation 2 is picture creation, the creation managing platform 1 may be configured to permit the creator 3 to set the corresponding key words (for example, the aforementioned sky, sea, sun, etc.) for the object elements in the picture creation when uploading. In the step S20, the AI model may use the key words as the basic unit to divide the picture creation.

The aforementioned description is part of the embodiments of the disclosure, here is not intended to be limiting.

After the step S20, the AI model may be configured to further respectively label the fragmentary creations 21 according to the text record obtained in the step S18 (step S22). In the disclosure, the labeled fragmentary creations 21 may be searched by the user 4 on the creation managing platform 1 and further be purchased or/and used.

It is worth mentioning that, in the step S22, the AI model may be configured to perform data cleansing to each fragmentary creation 21 in advance, and then label each fragmentary creation 21, here is not intended to be limiting. The detail of the data cleansing is omitted here for brevity.

For example, the fragmentary creations 21 of the article creation are corresponding to different paragraphs of the article. In the step S22, the AI model may extract the text, abstract, or key point of each paragraph from the text record to label each fragmentary creation 21. For another example, the fragmentary creations 21 of the music creation are corresponding to different time periods of the music. In the step S22, the AI model may extract the lyrics in each time period from the text record or generate corresponding scenario description based on the music or lyrics to label each fragmentary creation 21.

For another example, the fragmentary creations 21 of the video creation are corresponding to different time periods of the video. In the step S22, the AI model may extract the lines in each time period from the text record or generate corresponding scenario description based on the screen or background music to label each fragmentary creation 21. For another example, the fragmentary creations 21 of the picture creation are corresponding to different object elements of the picture. In the step S22, the AI model may extract the key words corresponding to each object element from the text record to label each fragmentary creation 21. For another example, the fragmentary creations 21 of the program code creation are corresponding to different functional sections of the program code. In the step S22, the AI model may extract the function description, syntax or key word corresponding to each functional section from the text record to label each fragmentary creation 21.

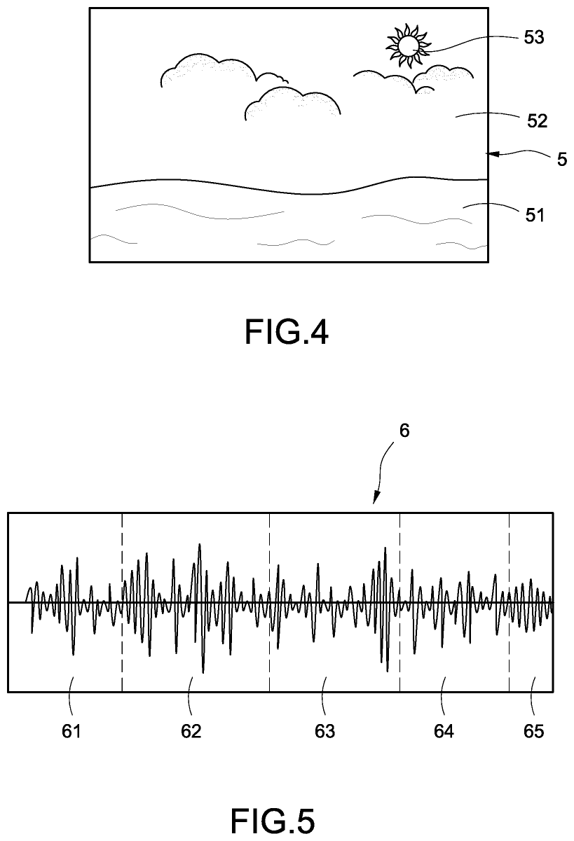

Please refer to FIG. 1, FIG. 2 and FIG. 4, FIG. 4 is a schematic diagram of the first embodiment of the fragmentary creation in accordance with some embodiments. FIG. 4 is using the picture creation as an example to describe the managing method of the disclosure how to divide the digital creation 2 and label each fragmentary creation 21.

As shown in FIG. 4, the creation managing platform 1 may be configured to analyze the picture creation 5 by the algorithm in the step S16, and generate the text record corresponding to content of the picture creation 5 in the step S18, such as sea, sky, sun, etc.

In the step S20, the creation managing platform 1 may be configured to analyze the picture creation 5 by the AI model, and divide the picture creation 5 into a first fragmentary creation 51, a second fragmentary creation 52 and a third fragmentary creation 53 based on multiple intact object elements in the picture creation 5. In the embodiment of FIG. 4, the first fragmentary creation 51 is corresponding to the sea image in the picture creation 5, the second fragmentary creation 52 is corresponding to the sky image in the picture creation 5, and the third fragmentary creation 53 is corresponding to the sun image in the picture creation 5.

In the step S22, the AI model may be configured to further label each fragmentary creation according to the text record. For example, the first fragmentary creation 51 is labeled as “sea”, the second fragmentary creation 52 is labeled as “sky”, and the third fragmentary creation 53 is labeled as “sun”. As a result, when the user 4 uses “sea” as the key word to search on the creation managing platform 1, the first fragmentary creation 51 is being obtained. When the user 4 uses “sky” as the key word to search on the creation managing platform 1, the second fragmentary creation 52 is being obtained, and so on.

Please refer to FIG. 1, FIG. 2 and FIG. 5, FIG. 5 is a schematic diagram of the second embodiment of the fragmentary creation in accordance with some embodiments. FIG. 5 is using the music creation as an example to describe the managing method of the disclosure how to divide the digital creation 2 and label each fragmentary creation 21.

As shown in FIG. 5, the creation managing platform 1 may be configured to analyze the music creation 6 by the algorithm in the step S16, and generate the text record corresponding to content of the music creation 6 in the step S18. In some embodiments, the text record may be, for example, lyrics of the music creation 6, or section description, such as prelude, verse, chorus, interlude, epilogue, etc., or scenario description, such as lyric, rock, sentimental, etc., or the key work set by the creator 3, here is not intended to be limiting.

In some embodiments, in the step S20, the creation managing platform 1 may be configured to analyze the music creation 6 by the AI model, and divide the music creation 6 into a first fragmentary creation 61, a second fragmentary creation 62, a third fragmentary creation 63, a fourth fragmentary creation 64 and a fifth fragmentary creation 65 based on the fixed time period (for example, ten second) in the music creation 6. In some embodiments, the first fragmentary creation 61 to the fifth fragmentary creation 65 are respectively corresponding to 0-9 seconds, 10-19 seconds, 20-29 seconds, 30-39 seconds, and 40-49 seconds of the music creation 6.

In some other embodiments, the AI model may be configured to divide the music creation 6 into the first fragmentary creation 61 to the fifth fragmentary creation 65 based on the music sections. In some embodiments, the first fragmentary creation 61 to the fifth fragmentary creation 65 may be, for example, corresponding to the prelude, verse, chorus, interlude, and epilogue of the music creation 6.

In the step S22, the AI model may be configured to further label each fragmentary creation according to the text record. For example, the first fragmentary creation 61 is labeled as “music”, “guitar playing”, “lyric”, “prelude”, etc., the second fragmentary creation 62 is labeled as verse lyrics, the third fragmentary creation 63 is labeled as chorus lyrics, the fourth fragmentary creation 64 is labeled as “music”, “piano playing”, “rock”, “interlude”, etc., and the fifth fragmentary creation 65 is labeled as “music”, “band playing”, “symphony”, “epilogue”, etc. As a result, the user 4 may input key word of required atmosphere or content on the creation managing platform 1 to search and obtain the first fragmentary creation 61 to the fifth fragmentary creation 65 corresponding to the required music sections.

The aforementioned description is part of the embodiments of the disclosure, here is not intended to be limiting.

Referring back to FIG. 2, after the step S22, the AI model is configured to compute the weighting value of each fragmentary creation 21 relative to the entire digital creation 2 (step S24). In some embodiments, the sum of all weighting values of the fragmentary creations 21 is one.

Specifically, in the step S24, the AI model may be configured to determine the value of each fragmentary creation 21 relative to the digital creation based on the text record corresponding to each fragmentary creation 21. Therefore, the AI model may compute the weighting value of each fragmentary creation 21 based on the value.

In some embodiments, the manager of the creation managing platform 1 may train the AI model through the combination of CNN and deep learning. By the accumulation and training with big data, the AI model may analyze the input digital creation 2 (the text record) to reasonably evaluate the value of each fragmentary creation 21 relative to the entire digital creation to further determine the weighting value of each fragmentary creation 21.

Further, after each fragmentary creation 21 is being searched, purchased, or/and used on the creation managing platform 1, the creation managing platform 1 may be configured to record the information such as frequency, time, review of being searched, purchased, or/and used. As a result, the AI model may adjust the weighting value of each fragmentary creation 21 according to the state of each fragmentary creation 21 being searched, purchased, or used. That is, the AI model may be configured to give suggested weighting value according to the past experience (that is, the result of deep learning), and the weighting value of each fragmentary creation 21 is changeable following the elapsed time after being uploaded.

Taking the music creation as an example, if the text record (for example, lyrics) corresponding to the fragmentary creation 21 has repeated text, that may indicate the part is catchy, has higher proportion in the music creation (for example, chorus), or has higher probability of being searched. Thus, the AI model may recognize that the value of the fragmentary creation 21 is higher after deep learning.

Taking the picture creation as an example, if the text record (for example, description for the object element) corresponding to the fragmentary creation 21 has general text, such as blue sky, sports car, etc., that may indicate the part has greater area (for example, blue sky) or is conspicuous (for example, sports car) in the entire picture creation, and has higher probability of being searched. Thus, the AI model may recognize that the value of the fragmentary creation 21 is higher after deep learning.

In the step S24, the creation managing platform 1 is configured to compute the weighting value of each fragmentary creation 21 relative to the entire digital creation 2 through the pre-trained AI model. In the disclosure, the AI model is trained through deep learning. Based on huge amount of digital creation to perform deep learning, the AI model may learn the importance of the parameters, such as all kinds of text record, creation section, creation content, relative to the entire digital creation 2, and further compute the weighting value of each part (for example, each fragmentary creation 21) in the digital creation 2.

The detail of the deep learning is omitted here for brevity.

Referring back to FIG. 2, after the step S24, the creator 3 may obtain the suggested weighting value of each fragmentary creation 21 from the AI model on the creation managing platform 1. In some embodiments, the creation managing platform 1 may be configured to simultaneously give the determination standard of the weighting value as reference for the creator 3. For example, the creation managing platform 1 may be configured to display the explanation of determination standard, such as “the first fragmentary creation is corresponding to the prelude of the song, the weighting value is 0.1; the third fragmentary creation is corresponding to the chorus of the song, the weighting value is 0.6”, “the first fragmentary creation is corresponding to the introduction of the article, the weighting value is 0.1; the fifth fragmentary creation is corresponding to the conclusion of the article, the weighting value is 0.4”. After the determination standard is confirmed, the creator 3 may choose to directly adopt the suggested determination standard from the creation managing platform 1 or not.

In some other embodiments, the creator 3 may modify the preliminarily suggested weighting value from the creation managing platform 1 through the user interface (not shown in figures) provided by the creation managing platform 1 (step S26). If the creator 3 choose to directly adopt the suggested determination standard from the creation managing platform 1, the step S26 may be omitted.

After the step S26, the weighting values of the fragmentary creations 21 in the digital creation 2 uploaded by the creator 3 are confirmed. Therefore, the creation managing platform 1 may be configured to compute the fragmentary price of each fragmentary creations 21 according to the price of the digital creation 2 set by the creator 3 and the weighting value of each fragmentary creations 21 (step S28). It is worth mentioning that the sum of all weighting values of the fragmentary creations 21 is one, thereby the sum of all fragmentary prices of the fragmentary creations 21 being the price of the digital creation 2.

In some other embodiments, the creator 3 may set the charging approach to be free payment approach in the step S12. In some embodiments, the creation managing platform 1 does not need to calculate the fragmentary price of each fragmentary creations 21. That is, the step S28 may be omitted.

After the step S28, the creation managing platform 1 may be configured to display a confirmation window of instantiating the smart contract or not through the user interface (step S30). After the user 3 confirmed, the creation managing platform 1 may store the charging approach and profit-sharing mode set by the creator 3, multiple labeled fragmentary creations 21, weighting value of each fragmentary creation and fragmentary price, thereby generating the online (for example, on the blockchain) executable smart contract (step S32).

In some embodiments, the smart contract is instantiated on the blockchain, and may include the encrypted signature of the creator 3 and the tracking code of the digital creation 2. As a result, after the creation managing platform 1 executes the smart contract and the user 4 downloads one or multiple fragmentary creations 21 on the creation managing platform 1, the source of the fragmentary creations 21 may be effectively tracked and authenticated to achieve the purpose of traceability.

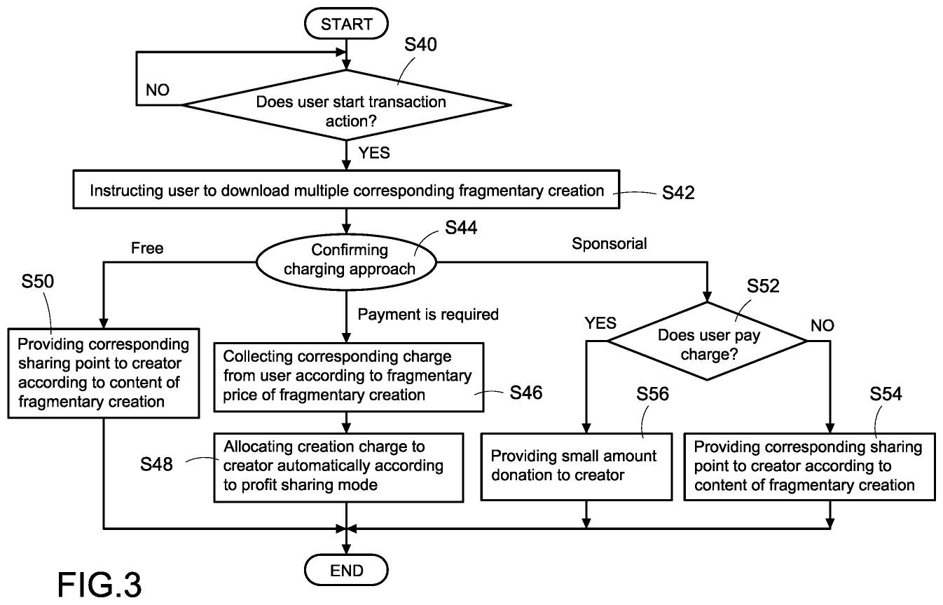

Please refer to FIG. 1, FIG. 2 and FIG. 3, FIG. 3 is a flowchart of the second embodiment of the managing method in accordance with some embodiments. FIG. 3 is used to describe the creation managing platform 1 how to execute the smart contract after the creator 3 uploads the digital creation 2 and instantiates the smart contract.

As shown in the FIG. 3, first, when the smart contract corresponding to the digital creation 2 is instantiated, the creation managing platform 1 may be configured to directly execute the smart contract, and continuously determine whether to accept the transaction action activated by the user 4 with respect to one or multiple fragmentary creation 21 in the smart contract (step S40). If the user 4 executes the action unrelated to the smart contract on the creation managing platform 1, the creation managing platform 1 does not execute any actions with respect to the smart contract.

If the user 4 executes the action related to the smart contract on the creation managing platform 1, the creation managing platform 1 is configured to instruct the user 4 to download and use one or multiple fragmentary creations 21 indicated by the transaction actions (step S42), and confirm the charging approach set by the creator 3 based on content of the smart contract (step S44). In some embodiments, the charging approach may include a requiring payment approach, a free payment approach and a sponsorial payment approach, here is not intended to be limiting.

If the smart contract indicates the charging approach is the requiring payment approach, the creation managing platform 1 is configured to charge the user 4 correspondingly according to the fragmentary prices of one or multiple fragmentary creations 21 indicated by the smart contract (step S46). Further, the creation managing platform 1 is configured to confirm the profit-sharing mode set by the creator 3 based on content of the smart contract, and automatically allocate creation charge to the creator 3 according to the profit-sharing mode (step S48).

For example, if the profit-sharing mode set in the smart contract is immediate payment, the creation managing platform 1 is immediately allocating the creation charge to the creator 3 after the step S46. If the profit-sharing mode set in the smart contract is monthly payment, the creation managing platform 1 is allocating the accumulated creation charge to the creator 3 once per month. It is worth mentioning that, when the smart contract is being instantiated, the creator 3 may further set to receive fiat currency or digital currency.

If the charging approach recorded in the smart contract is determined to be the free payment approach in the step S44, the creation managing platform 1 does not charge the user 4. Relatively, the creation managing platform 1 is configured to provide the corresponding sharing point to the creator 3 according to content of the used one or multiple fragmentary creations 21 (step S50). In some embodiments, the sharing point is equivalent to virtual currency for the creator 3 to purchase or/and use the digital creations 2 and fragmentary creations 21 uploaded by the other creators 3 on the creation managing platform 1. The creator 3 may be encouraged to upload the creation to the creation managing platform 1 for sharing by the reward manner.

If the charging approach recorded in the smart contract is determined to be the sponsorial payment approach in the step S44, the creation managing platform 1 may be configured to further determine whether the user pays the fee when downloading the fragmentary creation 21 (step S52). Specifically, the profit-sharing mode of the sponsorial payment approach indicates that the creator 3 may still set a price for the uploaded digital creation 2, but the user 4 may choose to pay the fee or not when downloading and using the creation.

If the charging approach in the smart contract is the sponsorial payment approach and the user 4 does not pay the fee, the creation managing platform 1 does not charge the user 4. On the other hand, in the embodiment, the creator 3 is freely providing the creation, and thus the creation managing platform 1 may provide the corresponding sharing point to the creator 3 according to content of the used one or multiple fragmentary creations 21 (step S54).

If the charging approach in the smart contract is the sponsorial payment approach and the user 4 pays the fee, the creation managing platform 1 is configured to charge the user 4, and in the embodiment, the creation managing platform 1 may additionally provide a small amount donation to the creator 3 (step S56). In some embodiments, the small amount donation is less than the sum of the fragmentary prices of the used one or multiple fragmentary creations 12. In some other embodiments, the small amount donation is incentive fee, for example, one cup of coffee. The aforementioned description is part of the embodiments of the disclosure, here is not intended to be limiting.

As described above, the smart contract of the disclosure is instantiated on the blockchain, and thus may also be implemented computer program. Specifically, the computer program product of the disclosure may be configured to record the related computer program for executing the smart contract. When the computer program is executed by computer or server (that is, the creation managing platform 1), the steps shown in FIG. 3 may be completed to execute the smart contract and perform the procedures, such as transaction, authorization, tracing, and authentication, etc., of the fragmentary creation 21.

The disclosure further discloses a computer readable storage medium, such as hard-disk drive, optical disk, flash disk, memory, etc. The storage medium records the computer executable codes in the computer program product. When computer or server (that is, the creation managing platform 1) reads the storage medium and executes the computer executable codes, the execution steps (as shown in FIG. 2 and FIG. 3) in the managing method of the disclosure may be implemented.

Through the managing method and the storage medium recorded the computer program product in the disclosure, the creation managing platform 1 may automatically segment the digital creation into multiple fragmentary creations and manage the fragmentary creations. The user 4 does not need to purchase the entire digital creation in order to use a part in the digital creation. Therefore, the user 4 may be encouraged to pay for using the creation. Further, the creator of the digital creation may continuously make a profit based on the used fragmentary creation to effectively achieve a win-win situation.

While this disclosure has been described by means of specific embodiments, numerous modifications and variations may be made thereto by those skilled in the art without departing from the scope and spirit of this disclosure set forth in the claims.

What is claimed is:

1. A managing method of a fragmentary digital creation, incorporated with a creation managing platform, the method comprising:
a) receiving, by the creation managing platform, a digital creation being uploaded;
b) receiving a setting command to set a charging approach, a price, and a profit-sharing mode;
c) processing the digital creation, by an algorithm, to generate a text record corresponding to content of the digital creation;
d) analyzing the digital creation, by an artificial intelligence model, to divide the digital creation into multiple fragmentary creations;
e) respectively labeling the fragmentary creations according to the text record;
f) calculating a weighting value of each fragmentary creation relative to the digital creation as a whole;
g) calculating a fragmentary price of each fragmentary creation according to the price and the weighting value; and
h) storing the charging approach, the profit-sharing mode, multiple labeled fragmentary creations, each weighting value and each fragmentary price to generate a smart contract of being executed online.

2. The method according to claim 1, wherein the digital creation comprises at least one of an article creation, a picture creation, a video creation, a music creation, and a program code creation.

3. The method according to claim 2, wherein the c) further comprises:
executing an optical character recognition (OCR) algorithm to the article creation to generate the text record corresponding to content of the article creation, executing a speech to text algorithm to the picture creation with voice, the video creation with voice and the music creation with voice to generate the text record corresponding to content of the picture creation, the video creation, the music creation, or analyzing multiple functional sections in the program code creation to generate the text record corresponding to content of the program code creation.

4. The method according to claim 2, wherein the d) further comprises:
dividing the article creation with a base unit of an article paragraph, dividing the video creation and the music with the base unit of a fixed time period, dividing the picture creation with the base unit of an intact object element, and dividing the program code creation with the base unit of a functional section.

5. The method according to claim 2, wherein the charging approach comprises a requiring payment approach, a free payment approach and a sponsorial payment approach, and further comprises a charging standard of different using time, a charging standard of different using locations and a charging standard of using manners.

6. The method according to claim 2, wherein the creation managing platform is instantiated on a blockchain, the smart contact is executed on the blockchain, and the smart contract comprises an encrypted signature of a provider of the digital creation and a tracking code of the digital creation.

7. The method according to claim 2, wherein the f) further comprises:
determining a value of each fragmentary creation relative to the digital creation according to the text record corresponding to each fragmentary creation to calculate the weighting value of each fragmentary creation based on the value, and adjusting the weighting value of each fragmentary creation according to a searched state, a purchased state, or a used state of each fragmentary creation.

8. The method according to claim 2, further comprising:
i) when the creation managing platform is configured to execute a transaction action initiated by a user, instructing the user to download the fragmentary creation indicated by the transaction action;
j) confirming the charging approach of the fragmentary creation;
k) when the charging approach is a requiring payment approach, charging the user according to the fragmentary price of the fragmentary creation; and
l) allocating a creation charge to a creator of the fragmentary creation according to the profit-sharing mode of the fragmentary creation.

9. The method according to claim 8, further comprising:
m) when the charging approach is a free payment approach, providing a sharing point to the creator correspondingly according to content of the fragmentary creation, wherein the sharing point is used for downloading and using another fragmentary creation on the creation managing platform;
n) when the charging approach is a sponsorial payment approach, determining whether the user pays a fee;
o) after the n), if the user pays the fee, allocating a donation to the creator; and
p) after the n), if the user does not pay the fee, providing the creator the sharing point correspondingly according to content of the fragmentary creation.

10. A computer readable storage medium, configured to record a computer executable code, when a computer or a server is configured to read the computer readable storage medium and execute the computer executable code, following steps being executed:
a) receiving a digital creation being uploaded;
b) receiving a setting command to set a charging approach, a price, and a profit-sharing mode;
c) processing the digital creation, by an algorithm, to generate a text record corresponding to content of the digital creation;
d) analyzing the digital creation, by an artificial intelligence model, to divide the digital creation into multiple fragmentary creations;
e) respectively labeling the fragmentary creations according to the text record;
f) calculating a weighting value of each fragmentary creation relative to the digital creation as a whole;
g) calculating a fragmentary price of each fragmentary creation according to the price and the weighting value; and
h) storing the charging approach, the profit-sharing mode, multiple labeled fragmentary creations, each weighting value and each fragmentary price to generate a smart contract of being executed online.
